(19) United States
(12) Patent Application Publication
(10) Pub. No.: US 2012/0075466 A1
(43) Pub. Date: Mar. 29, 2012

(54) REMOTE VIEWING

(75) Inventor: Larry C. Budnick, Wayland, MA (US)

(73) Assignee: Raytheon Company, Waltham, MA (US)

(21) Appl. No.: 12/893,206

(22) Filed: Sep. 29, 2010

(51) Int. Cl. H04N 7/18

(52) U.S. Cl. 348/143; 348/E07.085

(57) ABSTRACT

In one aspect, a method of remote viewing includes receiving a location on a projection screen illuminated by an infrared pointer, moving a pan-tilt-zoom (PTZ) camera to an area corresponding to the location on the projection screen illuminated by the infrared pointer and rendering the image from the PTZ camera to a display of an optical device comprising the infrared pointer.

### BACKGROUND

Sometimes it is desirable to view a hazardous environment from a remote location. For example, cameras may be set-up to view the remote location and images from these cameras are projected onto a screen in a location that is safer than the remote location. For example, remote cameras may be used on runaways of remote airports where air traffic controller are not available. In another example, remote cameras may be used at hazardous material storage facilities.

### SUMMARY

In one aspect, a method to remotely view an area of interest includes receiving a location on a projection screen illuminated by an infrared pointer, moving a pan-tilt-zoom (PTZ) camera to an area corresponding to the location on the projection screen illuminated by the infrared pointer and rendering the image from the PTZ camera to a display of an optical device comprising the infrared pointer.

In another aspect, an article includes a non-transitory machine-readable medium that stores executable instructions to remotely view an area of interest. The instructions cause a machine to receive a location on a projection screen illuminated by an infrared pointer, move a pan-tilt-zoom (PTZ) camera to an area corresponding to the location on the projection screen illuminated by the infrared pointer of an optical device and render the image from the PTZ camera to a display of the optical device.

In a further aspect, a remote viewing system includes an optical device that includes an infrared pointer and a display depicting images from a pan-tilt-zoom (PTZ) camera located in a remote area. The system also includes an infrared sensor configured to determine a location on a first projection screen illuminated by the infrared pointer and a processor configured to rotate the PTZ camera to a portion of a remote area corresponding to the location on the first projection screen illuminated by the infrared pointer.

### DESCRIPTION OF THE DRAWINGS

FIG. 1 is a block diagram of a remote viewing system.

FIG. 2 is a view of an example of an optical device.

FIG. 3 is a flowchart of an example of a process to view an area of interest remotely.

FIG. 4 is a flowchart of an example of a process to calibrate the remote viewing system.

FIG. 5 is a flowchart of an example of a process to correct for lens distortion of the remote viewing system.

FIG. 6 is a flowchart of an example of a process to acquire a detailed image.

FIG. 7 is a flowchart of an example of a process to render the detailed image.

FIG. 8 is a computer on which any one of or part of the processes of FIGS. 3 to 7 may be implemented.

### DETAILED DESCRIPTION

Described herein is an approach to view an area of interest remotely. In particular, a user may concentrate on a portion of a remote scene by pointing an optical device towards a projected image of the scene and viewing a detailed (e.g., zoomed) image inside the optical device. The optical device resembles binoculars, a telescope or the like to give the use the “look and feel” of actually being at the remote area of interest and looking for a detailed view. In one example, providing this “virtual binocular” would allow air traffic controllers, for example, to obtain closer views in a natural manner and allow them to keep the look and feel of their current operations.

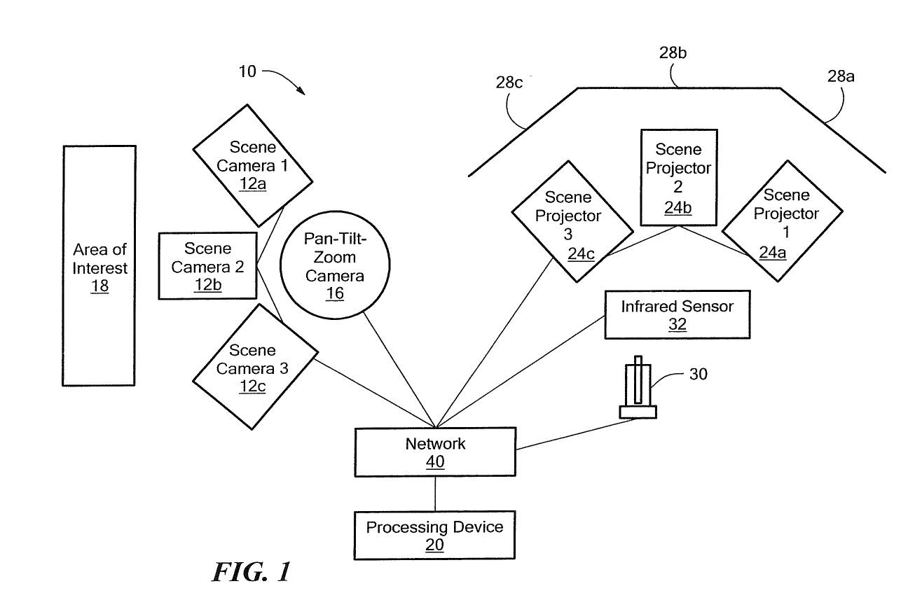

Referring to FIG. 1 a remote viewing system 10 includes scene cameras (e.g., a scene camera 12a, a scene camera 12b and a scene camera 12c), a pan-tilt-zoom (PTZ) camera 16, a processing device 20, scene projectors (e.g., a scene projector 24a, a scene projector 24b, and a scene projector 24c), an optical device 30 and an infrared (IR) sensor 32, each connected by a network 40. In some examples, the network 40 is a wireless network, a wired network or a combination of a wired and wireless network. The system 10 also includes projection screens (e.g., a projection screen 28a, a projections screen 24b and a projections screen 24c).

The scene cameras 12a-12c and the PTZ camera 16 take images of a remote area of interest 18. As used herein “remote” refers to the area of interest 18 being remote from (e.g., not collocated with) the scene projector 24a-24c and the projection screens 28a-28c. In some examples, the scene projector 24a-24c and the projection screens 28a-28c may be hundred of yards to many thousands of miles away from the area of interest 18.

Images of the area of interest 18 are taken by the scene cameras 12a-12c, processed by the processor device 20 and sent to the projectors 24a-24c for projection onto the projection screens 28a-28b. In one particular example, the scene camera 12a takes an image from a portion of the area of interest 18 which is projected by the corresponding scene projector 24a onto a corresponding projection screen 28a, the scene camera 12b takes an image from another portion of the area of interest 18 which is projected by the corresponding scene projector 24b onto a corresponding projection screen 28b and the scene camera 12c takes an image from a further portion of the area of interest 18 which is projected by the corresponding scene projector 24c onto the corresponding projection screen 28c. As a result, the images projected on the projection screens 28a-28c present a single panoramic view of the area of interest 18. In one example, the panoramic view may be a small portion of a 360° view. In another example, the entire 360° view may be presented using a multiplicity of projectors with flat or curved screen section surrounding a remote observer.

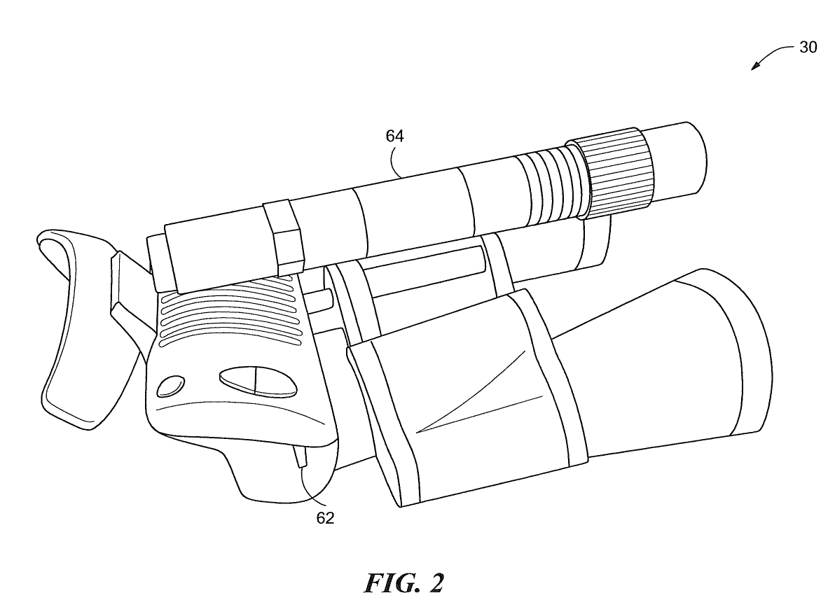

Referring to FIGS. 2A to 2B, the optical device 30 includes a display 62 and an infrared (IR) pointer 64. In one example, the optical device 30 looks like binoculars; however, when a user looks inside the eyes pieces, the user sees what is rendered on the display 62. In particular, the display 62 renders images from the PTZ camera 16. The IR pointer 64 is positioned on the optical device 30 so that IR pointer 64 points in a direction P where the optical device 30 is also pointing so that a user looks into the optical device 30 pointing towards the desired location for detailed viewing. In other examples, the optical device 30 looks like a telescope.

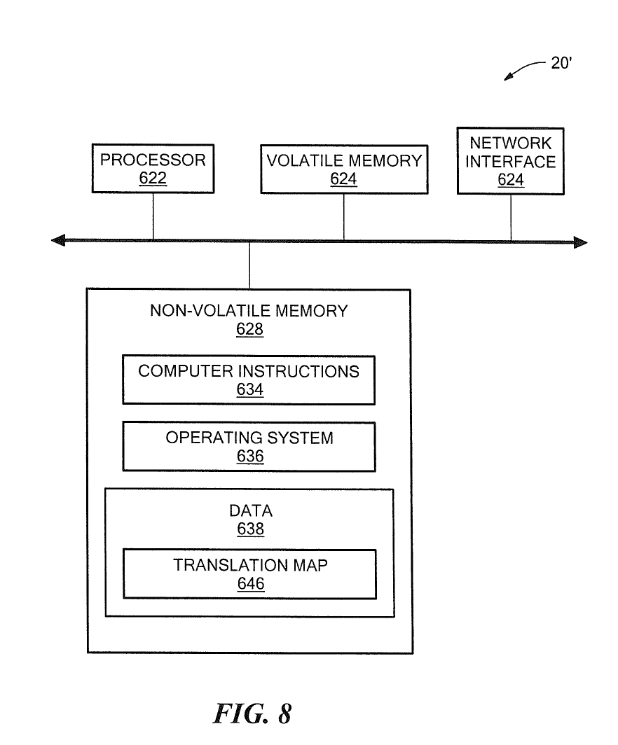

In one particular example, the user wishes to concentrate on a location rendered on the screens 28a-28c. The user points the optical device 30 towards the desired location on the screens 28a-28c and views the detailed image on the display 62 in the optical device 30. As the user, points towards the desired location, the IR pointer 64 illuminates a location on the screens 28a-28c. The IR sensor 32 determines the location on the projection screens 28a-28c. In one example, the x-y coordinates of the location on the projection screens 28a-28c are determined. Based on the location, the processing device 30 determines using a translation map (e.g., a translation map 646 (FIG. 8)) where the PTZ camera 16 should be pointing in the area of interest 18 in order to render a detailed image onto the display 62 in the optical device 30.

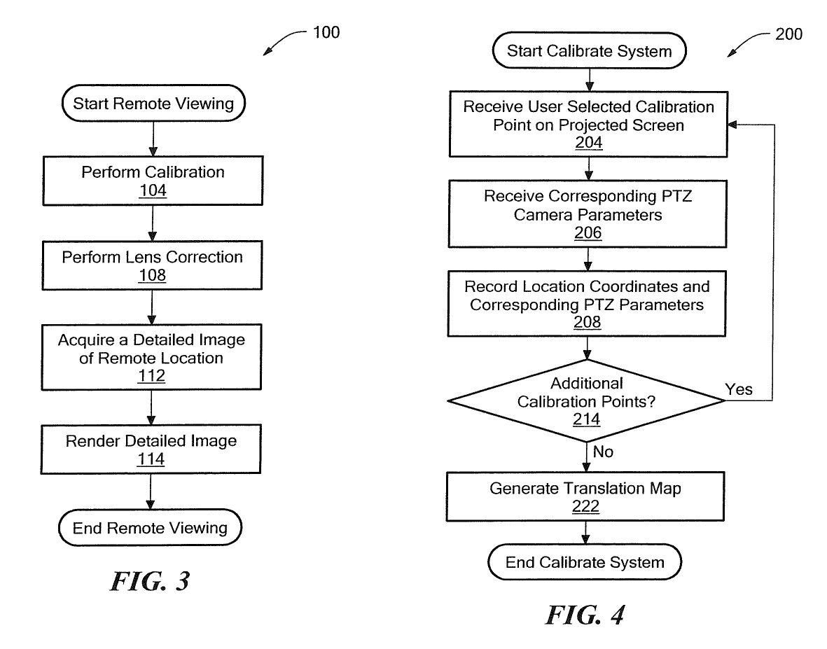

Referring to FIG. 3, one example of a process to view an area of interest remotely is a process 100. Process 100 performs a calibration (104). For example, the translation map is generated that correlates a location on the projection screens 28a-28c with parameters to control the PTZ camera 16. Process 100 performs a lens correction calibration to allow projected images from projectors 24a-24c to appear seamless and as a panorama (108). Adjustments include barrel correction, keystone and cropping. Other corrections may be specified depending on the type of lenses used for capture and correction. Process 100 acquires a detailed (e.g., zoomed-in) image of the area of interest (112). For example, the location illuminated by the IR pointer 64 is detected by the infrared sensor 32 and translated using the translation map to commands to position the PTZ camera 16 and a high resolution image is acquired. Process 100 renders the detailed image (114).

Referring to FIG. 4, one example of a process to perform calibration is a process 200. Process 200 receives a location on the screen selected (204). In one example, a user selects a location on the screens 28a-28c and the IR sensor determines the location on the screens 28a-28c. Process 200 receives the corresponding PTZ camera parameters (206). For example, the user points the PTZ camera 16 to the location corresponding to the user selected location on the projection screens 28a-28c. In one example, the PTZ parameters include pan, tilt and zoom parameters. Process 200 records the location of the coordinates corresponding to the location and the corresponding PTZ camera parameters for the PTZ camera 16 (208).

Process 200 determines if additional calibration points exist (214). If additional calibration points are needed, processing blocks 204, 208 are repeated for each calibration pointed. If additional calibration points do not exist, process 200 generates the translation map (222). As one of ordinary skill in the art would recognize other ways of determining the PTZ camera parameters may be determined based on a location on the projection screens 28a-28c. In other examples, the calibration points and corresponding PTZ camera parameters may be used to calculate a formula (equation) so that PTZ camera parameters may be determined for any location on the projection screens 28a-28c.

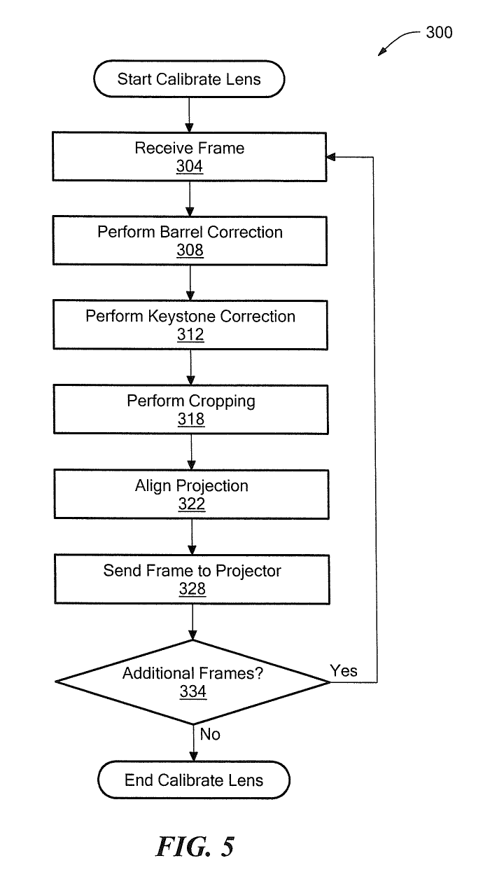

Referring to FIG. 5, one example of a process to correct a lens is a process 300. Process 300 receives a frame (304). Process 300 performs barrel correction (308), keystone correction (312) and cropping (318). Barrel correction is one of many image alterations used to connect lens image distortions that are required so that when multiple images are displayed in a panorama format, the edges and objects appear uniform. Keystone corrects for distortions introduced by the angle of the projector (e.g., when projecting onto an eye-level screen, but the projectors are on the ceiling). Process 300 aligns the projection on the screens 28a-28c (322) and sends the frame to the projector (328)

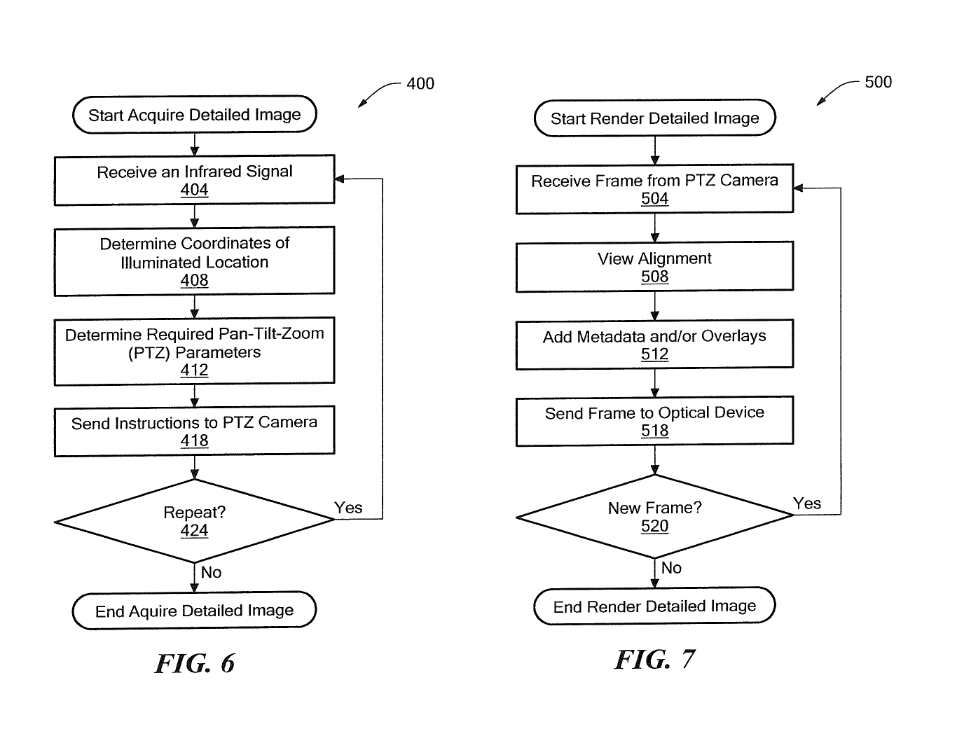

Referring to FIG. 6, one example of a process to acquire a detailed image is a process 400. Process 400 receives an infrared signal (404). For example, the infrared sensor 32 receives the location of the illuminated portion of the screens 28a-28c illuminated by the IR pointer 64. Process 400 determines the coordinates of the location illuminated by the infrared pointer 64 (408). In one example, the x-y coordinates are determined. Process 400 determines the required PTZ camera parameters using the translation map (412) and sends instructions to the PTZ camera (418). Process 400 determines if the processing blocks 404-418 should be repeated (424).

Referring to FIG. 7, one example of a process to render the detailed image is a process 500. Process 500 receives an image frame from the PTZ camera 16 (504). Process 500 aligns the image frame and adds metadata and/or overlays (512). In one example, metadata is textual or graphical information that is not visible in the scene itself, for example, distance to a target, altitude of a target, conditions at the remote site such as wind, temperature and so forth. Graphical information may include graphical overlays such as computer-enhanced edge detection, pseudo-coloring based on object temperature (using thermal cameras) and so forth. Other metadata may include information such as nuclear, explosive, vapor chemical and/or biological detections from remote sensors. Process 500 sends the frame image to the optical device 20 for rendering on the display 62 (518). Process 500 determines if a new image frame is received (520). If a new image frame is received processing blocks 504-520 are repeated.

Referring to FIG. 8, one example of the processing device 20 is a computer 20′. The computer 20′ includes a processor 622, a volatile memory 624, a non-volatile memory 628 (e.g., hard disk) and a network interface to communicate with the scene camera 12a-12c, the PTZ camera 16, the scene projectors 24a-24c and the optical device 30. The non-volatile memory 628 stores computer instructions 634, an operating system 636 and data 638. In one example, the data 638 includes a translation map 646. In one example, the computer instructions 634 are executed by the processor 622 out of volatile memory 628 to perform all or part of the processes described herein (e.g., the processes 100-500).

The processes described herein (e.g., the processes 100-500) are not limited to use with the hardware and software of FIG. 8; they may find applicability in any computing or processing environment and with any type of machine or set of machines that is capable of running a computer program. The processes described herein may be implemented in hardware, software, or a combination of the two. The processes described herein may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform any of the processes described herein and to generate output information.

The system may be implemented, at least in part, via a computer program product, (e.g., in a machine-readable storage device), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform the processes described herein. The processes described herein may also be implemented as a machine-readable storage medium, configured with a computer program, where upon execution, instructions in the computer program cause the computer to operate in accordance with the processes.

The processes described herein are not limited to the specific embodiments described. For example, the processes are not limited to the specific processing order of FIGS. 3 to 7. Rather, any of the processing blocks of FIGS. 3 to 7 may be re-ordered, combined or removed, performed in parallel or in serial, as necessary, to achieve the results set forth above.

The processing blocks in FIGS. 3 to 7 associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Elements of different embodiments described herein may be combined to form other embodiments not specifically set forth above. Other embodiments not specifically described herein are also within the scope of the following claims.

What is claimed is:

1. A method to remotely view an area of interest comprising:
receiving a location on a projection screen illuminated by an infrared pointer;
moving a pan-tilt-zoom (PTZ) camera to an area corresponding to the location on the projection screen illuminated by the infrared pointer; and
rendering the image from the PTZ camera to a display of an optical device comprising the infrared pointer.

2. The method of claim 1, further comprising:
receiving images from a first camera located remotely from the projection screen; and
rendering the images from the first camera onto the projections screen using a first projector.

3. The method of claim 2, further comprising connecting the first camera, the first screen projector, the PTZ camera, the optical device, the infrared pointer and the processor to a network.

4. The method of claim 1, wherein the projection screen is a first projection screen, and
further comprising:
receiving images from a second camera located remotely from a second projection screen; and
rendering the images from the second camera onto the second projection screen using a second projector.

5. The method of claim 4, further comprising:
receiving a location on the second projection screen illuminated by the infrared pointer; and
moving a pan-tilt-zoom (PTZ) camera to point in an area corresponding to the location on the second projection screen illuminated by the infrared pointer.

6. The method of claim 1, further comprising:
generating a translation map to correlate the location on the projection screen to parameters to control the PTZ camera.

7. The method of claim 1 wherein receiving the location on the projection screen illuminated by an infrared pointer comprises receiving coordinates of the location using an infrared sensor.

8. An article comprising:
a non-transitory machine-readable medium that stores executable instructions to recover distorted digital data, the instructions causing a machine to:
receive a location on a projection screen illuminated by an infrared pointer;
move a pan-tilt-zoom (PTZ) camera to an area corresponding to the location on the projection screen illuminated by the infrared pointer of an optical device; and
render the image from the PTZ camera to a display of the optical device.

9. The article of claim 8, further comprising instructions causing the machine to:
receive images from a first camera located remotely from the projection screen; and
render the images from the first camera onto the projections screen using a first projector.

10. The article of claim 8, wherein the projection screen is a first projection screen, and
further comprising instructions causing the machine to:
receive images from a second camera located remotely from a second projection screen; and
render the images from the second camera onto the second projection screen using a second projector.

11. The article of claim 10, further comprising instructions causing the machine to:
receive a location on the second projection screen illuminated by the infrared pointer; and
move a pan-tilt-zoom (PTZ) camera to point in an area corresponding to the location on the second projection screen illuminated by the infrared pointer.

12. The article of claim 8, further comprising instructions causing the machine to:
generate a translation map to correlate the location on the projection screen to parameters to control the PTZ camera.

13. The article of claim 8 wherein the instructions causing the machine to receive the location on the projection screen illuminated by an infrared pointer comprises instructions causing the machine to receive coordinates of the location using an infrared sensor.

14. A remote viewing system comprising:
an optical device comprising:
an infrared pointer;
a display depicting images from a pan-tilt-zoom (PTZ) camera located in a remote area;
an infrared sensor configured to determine a location on a first projection screen illuminated by the infrared pointer; and
a processor configured to rotate the PTZ camera to a portion of a remote area corresponding to the location on the first projection screen illuminated by the infrared pointer.

15. The system of claim 14 wherein the optical device is constructed as binoculars.

16. The system of claim 14 wherein the optical device is constructed as a telescope.

17. The system of claim 14, further comprising a storage medium configured to store a translation map.

18. The system of claim 14, further comprising:
the first projection screen;
a first camera located remotely from the first projection screen;
a first screen projector configured to project visual images from the first camera onto to the first projection screen; and
a pan-tilt-zoom (PTZ) camera located with the first camera;

19. The system of claim 18, further comprising a network connecting the first camera, the first screen projector, the PTZ camera, the optical device, the infrared pointer and the processor.

20. The system of claim 19, further comprising:
a second projection screen;
a second camera located remotely from the second projection screen;
a second screen projector configured to project visual images from the second camera onto to the second projection screen;
wherein processor is further configured to rotate the PTZ camera to an area in the remote area corresponding to the location on the first or the second projection screen illuminated by the infrared pointer, and
wherein the infrared sensor is further configured to determine a location on the first or the second projection screen illuminated by the infrared pointer.
